(19) United States
(12) Patent Application Publication
(10) Pub. No.: US 2006/0094813 A1
(43) Pub. Date: May 4, 2006

(54) Glass-fiber-reinforced polymer compositions

(76) Inventors: Holger Warth, Dormagen (DE); Juha Hartikainen, Porvoo (FI); Mathias Lindner, Kaiserslautern (DE)

Correspondence Address: BAYER MATERIAL SCIENCE LLC, 100 BAYER ROAD, PITTSBURGH, PA, 15205, US

(21) Appl. No.: 11/245,414

(22) Filed: Oct. 6, 2005

(30) Foreign Application Priority Data
Oct. 11, 2004 (DE) 1020040496285
Aug. 27, 2005 (DE) 1020050406203

(51) Int. Cl. C08K 3/40

(52) U.S. Cl. 524/494

(57) ABSTRACT

A thermoplastic molding composition that contains long glass fibers is disclosed. The composition contain a) at least one polymer selected from the group consisting of polyamides, polycarbonates, polyester carbonates, graft polymers and copolymers, b) a terpolymer of styrene, acrylonitrile and maleic anhydride and c) long glass fibers, the diameter of the fiber filament being from 7 to 25 μm. The composition features improved mechanical properties.

### FIELD OF THE INVENTION

The invention relates to thermoplastic molding compositions and in particular to glass fibers-reinforced compositions.

### BACKGROUND OF THE INVENTION

DE 10 232 485 A1 describes a process for the production of glass- and/or carbon-fiber-reinforced moldings. Polyamides, polyalkylene terephthalate and polyphenylene sulfide are mentioned as thermoplastics. The reinforced polyamide compositions produced according to DE 10 232 485 A1 are distinguished by good bending stress, flexural strength and bending modulus.

Glass-fiber-reinforced polycarbonate molding compositions are likewise known. They are distinguished by particular rigidity in combination with low thermal expansion. When used in practice they exhibit a brittle breaking behavior at low temperatures, which can mean restrictions or more complex constructions in safety components.

U.S. Pat. No. 5,834,056 (incorporated herein by reference) disclosed an apparatus suitable for fiber bundle impregnation suitable in the practice of the present invention.

The object of the present invention is to provide compositions which exhibit an excellent combination of mechanical properties, in particular tensile strength, modulus of elasticity and impact strength.

This object has been achieved by providing thermoplastics, in particular blends, that include long glass fibers. The components are distinguished in particular by their breaking behavior at low temperatures.

### SUMMARY OF THE INVENTION

A thermoplastic molding composition that contains long glass fibers is disclosed. The composition contain a) at least one polymer selected from the group consisting of polyamides, polycarbonates, polyester carbonates, graft polymers and copolymers, b) a terpolymer of styrene, acrylonitrile and maleic anhydride and c) long glass fibers, the diameter of the fiber filament being from 7 to 25 μm. The composition features improved mechanical properties

### DESCRIPTION OF THE FIGURE

FIG. 1 is a diagrammatic representation of the wetting or impregnating process of the glass fibers.

### DETAILED DESCRIPTION OF THE INVENTION

The present invention is directed to a composition comprising

a) at least one polymer selected from the group consisting of polyamides, polycarbonates, polyester carbonates, graft polymers and copolymers,

b) a terpolymer of styrene, acrylonitrile and maleic anhydride and

c) long glass fibers, the diameter of the fiber filament being from 7 to 25 μm.

Preference is given to compositions comprising

A) at least one polymer selected from the group of the polyamides, polycarbonates and polyester carbonates,

B) at least one polymer selected from the group of the graft polymers and copolymers,

b) a terpolymer of styrene, acrylonitrile and maleic anhydride and

c) long glass fibers, the diameter of the fiber filament being from 7 to 25 μm.

In the context of the present invention, the terms “long glass fibers” and “filaments” are used as synonyms and represent an endless or continuous glass fiber, the length of which is only limited by the capacity of the spool whereon the filament is wound. The resulting fiber length in the granules is determined by the cut length of the granules.

Preferably, the compositions comprise from 30 to 99 parts by weight, preferably from. 45 to 95 parts by weight, particularly preferably from 50 to 95 parts by weight, especially from 50 to 90 parts by weight, of component A),

from 1 to 50 parts by weight, preferably from 1 to 40 parts by weight, particularly preferably from 3 to 35 parts by weight, especially from 5 to 30 parts by weight, of component B),

from 0.1 to 10 wt. %, preferably from 0.3 to 7 wt. %, particularly preferably from 0.5 to 6 wt. %, especially from 0.8 to 4 wt. % (based on the sum of the parts by weight of A) and B)), of terpolymer (c)-B.4,

and from 3 to 60 wt. %, preferably from 3 to 50 wt. %, particularly preferably from 5 to 40 wt. %, very particularly preferably from 7 to 35 wt. % and especially from 7 to 30 wt. % (based on 100 parts by weight of A) and B)), of component c).

Component A

Aromatic polycarbonates and/or aromatic polyester carbonates according to component A which are suitable according to the invention are known in the literature or can be prepared by processes which are known in the literature (for the preparation of aromatic polycarbonates see, for example, Schnell, “Chemistry and Physics of Polycarbonates”, Interscience Publishers, 1964 as well as DE-AS 1 495 626, DE-A 2 232 877, DE-A 2 703 376, DE-A 2 714 544, DE-A 3 000 610, DE-A 3 832 396; for the preparation of aromatic polyester carbonates see, for example, DE-A 3 077 934) all incorporated herein by reference.

The preparation of aromatic polycarbonates is carried out, for example, by reacting aromatic dihydroxy compounds, preferably diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents having a functionality of three or more, for example triphenols or tetraphenols.

Suitable aromatic dihydroxy compounds for the preparation of aromatic polycarbonates and/or aromatic polyester carbonates are preferably those of formula (I) 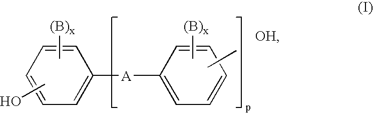
wherein

A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there may be condensed further aromatic rings optionally containing hetero atoms,

or a radical of formula (II) or (III) 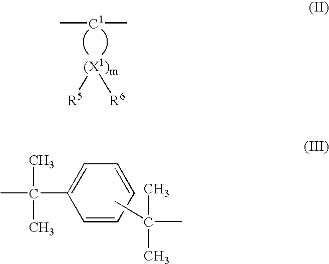
each of the substituents B represents C₁- to C₁₂-alkyl, preferably methyl, halogen, preferably chlorine and/or bromine,

the substituents x are each independently of the other 0, 1 or 2,

p represents 1 or 0, and

R⁵ and R⁶ can be selected individually for each X¹ and are each independently of the other hydrogen or C₁- to C₆-alkyl, preferably hydrogen, methyl or ethyl,

X¹ represents carbon, and

m represents an integer from 4 to 7, preferably 4 or 5, with the proviso that on at least one atom X¹, R⁵ and R⁶ are simultaneously alkyl.

Preferred aromatic dihydroxy compounds are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl) sulfoxides, bis-(hydroxyphenyl) ketones, bis-(hydroxyphenyl)-sulfones and α,α-bis-(hydroxyphenyl)-diisopropylbenzenes and their derivatives brominated and/or chlorinated on the ring.

Particularly preferred are diphenols such as 4,4′-dihydroxydiphenyl, bisphenol A, 2,4-bis-(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone and their di- and tetra-brominated or -chlorinated derivatives, such as, for example, 2,2-bis-(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. Special preference is given to 2,2-bis-(4-hydroxyphenyl)-propane (bisphenol A).

The aromatic dihydroxy compounds may be used individually or in the form of any desired mixtures. These are known and are commercially available.

Suitable chain terminators for the preparation of thermoplastic aromatic polycarbonates are, for example, phenol, p-chlorophenol, p-tert.-butylphenol or 2,4,6-tribromophenol, as well as long-chained alkylphenols, such as 4-(1,3-tetra-methylbutyl)-phenol according to DE-A 2 842 005, or monoalkylphenols or dialkylphenols having a total of from 8 to 20 carbon atoms in the alkyl substituents, such as 3,5-di-tert.-butylphenol, p-isooctylphenol, p-tert.-octylphenol, p-dodecylphenol and 2-(3,5-dimethylheptyl)-phenol and 4-(3,5-dimethylheptyl)-phenol. The amount of chain terminators to be used is generally from 0.5 mol. % to 10 mol. %, based on the molar sum of the diphenols used in a particular case.

The thermoplastic aromatic polycarbonates and polyester carbonates have weight-average molecular weights (M_{w}, measured by ultracentrifugation or scattered light measurement, for example) of from 10,000 to 200,000, preferably from 15,000 to 80,000.

The thermoplastic aromatic polycarbonates and polyester carbonates may be branched in a known manner, preferably by the incorporation of from 0.05 to 2.0 mol. %, based on the sum of the diphenols used, of compounds having a functionality of three or more, for example compounds having three or more phenolic groups.

Both homopolycarbonates and copolycarbonates are suitable. For the preparation of copolycarbonates according to the invention according to component A it is also possible to use from 1 to 25 wt. %, preferably from 2.5 to 25 wt. % (based on the total amount of diphenols to be used) of polydiorganosiloxanes having hydroxyaryloxy terminal groups. These compounds are known (for example U.S. Pat. No. 3,419,634) or can be prepared by processes known in the literature. The preparation of copolycarbonates containing polydiorganosiloxanes is described, for example, in DE-A 3 334 782.

In addition to the homopolycarbonates of bisphenol A, preferred polycarbonates are the copolycarbonates of bisphenol A containing up to 15 mol. %, based on the molar sum of diphenols, of diphenols other than those mentioned as being preferred or particularly preferred, in particular 2,2-bis-(3,5-dibromo-4-hydroxyphenyl)-propane.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacid dichlorides of isophthalic acid and terephthalic acid in a ratio of from 1:20 to 20:1.

In the preparation of polyester carbonates, a carbonic acid halide, preferably phosgene, is additionally used concomitantly as bifunctional acid derivative.

In addition to the monophenols already mentioned suitable chain terminators for the preparation of aromatic polyester carbonates include the chlorocarbonic acid esters of the mentioned monophenols and the acid chlorides of aromatic monocarboxylic acids, which may optionally be substituted by C₁- to C₂₂-alkyl groups or by halogen atoms, as well as aliphatic C₂- to C₂₂-monocarboxylic acid chlorides.

The amount of phenolic chain terminators is 0.1 to 10 mol. %, based on the moles of diphenols and in the case of monocarboxylic acid chloride chain terminators based on the moles of the dicarboxylic acid dichlorides.

The aromatic polyester carbonates may also contain residues of aromatic hydroxycarboxylic acids incorporated therein.

The aromatic polyester carbonates may be either linear or branched in a known manner (see in this connection also DE-A 2 940 024 and DE-A 3 007 934).

Suitable branching agents include carboxylic acid chlorides having a functionality of three or more, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in amounts of from 0.01 to 1.0 mol. % (based on dicarboxylic acid dichlorides used), or phenols having a functionality of three or more, such as phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxyphenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methylphenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytriphenyl)-methyl]-benzene, in amounts of from 0.01 to 1.0 mol. %, based on diphenols used.

The content of carbonate structural units in the thermoplastic aromatic polyester carbonates may vary as desired. The carbonate group content is preferably up to 80 mol. %, preferably up to 50 mol. %, based on the sum of ester groups and carbonate groups. Both the esters and the carbonates contained in the aromatic polyester carbonates may be present in the polycondensation product in the form of blocks or in a randomly distributed manner.

Polyamides suitable according to the invention are known and may be prepared according to known processes.

Suitable polyamides include homopolyamides, copolyamides and mixtures of such polyamides. They may be semi-crystalline and/or amorphous polyamides. Suitable semi-crystalline polyamides are polyamide-6, polyamide-6,6, mixtures and corresponding copolymers of these components. Also suitable are semi-crystalline polyamides whose acid component consists wholly or partially of terephthalic acid and/or isophthalic acid and/or suberic acid and/or sebacic acid and/or azelaic acid and/or adipic acid and/or cyclohexanedicarboxylic acid, whose diamine component consists wholly or partially of m- and/or p-xylylenediamine and/or hexamethylenediamine and/or 2,2,4-trimethylhexamethylenediamine and/or 2,4,4-trimethylhexamethylenediamine and/or isophoronediamine, and whose composition is known.

Mention may also be made of polyamides which are prepared wholly or partially from lactams having from 7 to 12 carbon atoms in the ring, optionally with the concomitant use of one or more of the above-mentioned starting components.

Particularly preferred semi-crystalline polyamides are polyamide-6 and polyamide-6,6 and mixtures thereof. Amorphous polyamides are known and may be used. They may be obtained by polycondensation of diamines, such as ethylenediamine, hexamethylenediamine, decamethylenediamine, 2,2,4- and/or 2,4,4-trimethylhexamethylenediamine, m- and/or p-xylylenediamine, bis-(4-aminocyclohexyl)-methane, bis-(4-aminocyclohexyl)-propane, 3,3′-dimethyl-4,4′-diamino-dicyclohexylmethane, 3-aminomethyl-3,5,5-trimethylcyclohexylamine, 2,5- and/or 2,6-bis-(aminomethyl)-norbornane and/or 1,4-diaminomethylcyclohexane, with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers obtained by polycondensation of a plurality of monomers, as well as copolymers comprising aminocarboxylic acids, such as ε-aminocaproic acid, ω-aminoundecanoic acid or ω-aminolauric acid or their lactams.

Particularly suitable amorphous polyamides are polyamides prepared from isophthalic acid, hexamethylenediamine and further diamines, such as 4,4-diaminodicyclohexylmethane, isophoronediamine, 2,2,4- and/or 2,4,4-trimethyl-hexamethylenediamine, 2,5- and/or 2,6-bis-(aminomethyl)-norbornene; or from isophthalic acid, 4,4′-diaminodicyclohexylmethane and ε-caprolactam; or from isophthalic acid, 3,3′-dimethyl-4,4′-diamino-dicyclohexylmethane and laurinlactam; or from terephthalic acid and the isomeric mixture of 2,2,4- and/or 2,4,4-trimethylhexamethylenediamine

Instead of pure 4,4′-diaminodicyclohexylmethane, it is also possible to use mixtures of the position isomers diaminedicyclohexalmethanes, which are composed of

from 70 to 99 mol. % of the 4,4′-diamino isomer,

from 1 to 30 mol. % of the 2,4′-diamino isomer and

from 0 to 2 mol. % of the 2,2′-diamino isomer,

optionally corresponding to more highly condensed diamines, which are obtained by hydrogenation of commercial grade diaminodiphenylmethane. The isophthalic acid may be replaced by up to 30% terephthalic acid.

The polyamides preferably have a relative viscosity (measured on a 1 wt. % solution in m-cresol at 25° C.) of from 2.0 to 5.0, particularly preferably from 2.5 to 4.0.

The polyamides may be contained in component A alone or in any desired mixture with one another.

Component B

Component B is a graft polymer of

B.1 from 5 to 95 wt. %, preferably from 30 to 90 wt. %, of at least one vinyl monomer on

B.2 from 95 to 5 wt. %, preferably from 70 to 10 wt. %, of one or more graft bases having glass transition temperatures <10° C., preferably <0° C., particularly preferably <−10° C.

The wt. % being relative to the weight of B.

The graft base B.2 has a median particle size (d₅₀ value) of from 0.05 to 10 μm, preferably from 0.1 to 5 μm, particularly preferably from 0.2 to 1 μm.

B.1 is preferably a mixture of

B.1.1 from 50 to 99 parts by weight of vinyl aromatic compounds and/or vinyl aromatic compounds substituted on the ring (such as styrene, α-methylstyrene, p-methylstyrene, p-chlorostyrene and/or (meth)acrylic acid (C₁-C₈)-alkyl esters (such as methyl methacrylate, ethyl methacrylate) and

B.1.2 from 1 to 50 parts by weight of vinyl cyanides (unsaturated nitriles, such as acrylonitrile and methacrylonitrile) and/or (meth)acrylic acid (C₁-C₈)-alkyl esters (such as methyl methacrylate, n-butyl acrylate, tert.-butyl acrylate) and/or derivatives (such as anhydrides and imides) of unsaturated carboxylic acids (for example maleic anhydride and N-phenylmaleimide).

Preferred B.1.1 is at least one member selected from the group consisting of the styrene, α-methylstyrene and methyl methacrylate; preferred B.1.2 is at least one member selected from the group consisting of acrylonitrile, maleic anhydride and methyl methacrylate.

Particularly preferred monomers are B.1.1 styrene and B.1.2 acrylonitrile.

Suitable graft bases B.2 for the graft polymers B include diene rubbers, EP(D)M rubbers, that is to say those based on ethylene/propylene and optionally diene, acrylate, polyurethane, silicone, chloroprene and ethylene/vinyl acetate rubbers.

Preferred graft bases B.2 are diene rubbers (e.g. based on butadiene, isoprene, etc.) or mixtures of diene rubbers or copolymers of diene rubbers or mixtures thereof with further copolymerisable monomers (e.g. according to B.1.1 and B.1.2), with the proviso that the glass transition temperature of component B.2 is <10° C., preferably <0° C., particularly preferably <−10° C.

Homopolmeric polybutadiene rubber is particularly preferred.

Particularly preferred polymers B are, for example, ABS polymers (emulsion, mass and suspension ABS), as are described, for example, in DE-A 2 035 390 (=U.S. Pat. No. 3,644,574) or in DE-A 2 248 242 (=GB-PS 1 409 275) or in Ullmanns, Enzyklopädie der Technischen Chemie, Vol. 19 (1980), p. 280 ff. The gel content of the graft base B.2 is at least 30 wt. %, preferably at least 40 wt. % (measured in toluene).

The graft copolymers B are prepared by free-radical polymerisation, for example by emulsion, suspension, solution or mass polymerisation, preferably by emulsion or mass polymerisation.

Particularly suitable graft rubbers are also ABS polymers prepared by redox initiation with an initiator system of organic hydroperoxide and ascorbic acid according to U.S. Pat. No. 4,937,285.

Suitable acrylate rubbers according to B.2 for the polymers B are preferably polymers of acrylic acid alkyl esters, optionally containing up to 40 wt. %, based on B.2, of other polymerisable, ethylenically unsaturated monomers. The preferred polymerisable acrylic acid esters include C₁-C₈-alkyl esters, for example methyl, ethyl, butyl, n-octyl and 2-ethylhexyl ester; haloalkyl esters, preferably halo-C₁-C₈-alkyl esters, such as chloroethyl acrylate, and mixtures of these monomers.

For crosslinking, monomers having more than one polymerisable double bond may be copolymerised. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, allyl methacrylate; polyunsaturated heterocyclic compounds, such as trivinyl cyanurate and triallyl cyanurate; polyfunctional vinyl compounds, such as di- and tri-vinylbenzenes; and also triallyl phosphate and diallyl phthalate.

Preferred crosslinking monomers are allyl methacrylate, ethylene glycol dimethacrylate, diallyl phthalate, and heterocyclic compounds containing at least three ethylenically unsaturated groups.

Particularly preferred crosslinking monomers are the cyclic monomers triallyl cyanurate, triallyl isocyanurate, triacryloylhexahydro-s-triazine, triallyl benzenes. The amount of crosslinking monomers is preferably from 0.02 to 5 wt. %, especially from 0.05 to 2 wt. %, relative to the graft base B.2.

In the case of cyclic crosslinking monomers having at least three ethylenically unsaturated groups, it is advantageous to limit the amount to less than 1 wt. % of the graft base B.2.

Preferred “other” polymerisable, ethylenically unsaturated monomers which may optionally be used, in addition to the acrylic acid esters, in the preparation of the graft base B.2 are, for example, acrylonitrile, styrene, α-methylstyrene, acrylamides, vinyl C₁-C₆-alkyl ethers, methyl methacrylate, butadiene. Preferred acrylate rubbers as the graft base B.2 are emulsion polymers having a gel content of at least 60 wt. %.

Further graft bases suitable as B.2 include silicone rubbers having graft-active sites, as are described in DE-A 3 704 657, DE-A 3 704 655, DE-A 3 631 540 and DE-A 3 631 539.

Suitable silicone-acrylate rubbers are described in JP 08 259 791-A, JP 07 316 409-A and EP-A 0 315 035. The relevant contents of the corresponding U.S. Pat. No. 4,963,619 are incorporated by reference herein.

The polyorganosiloxane component in the silicone-acrylate composite rubber may be prepared in an emulsion polymerisation process by reacting an organosiloxane and a multifunctional crosslinker. It is also possible to insert graft-active sites into the rubber by addition of suitable unsaturated organosiloxanes.

The organosiloxane is generally cyclic, the ring structures preferably containing from 3 to 6 Si atoms. Examples include hexamethylcyclotrisiloxane, octamethylcyclotetrasiloxane, decamethylcyclopentasiloxane, dodecamethyl-cyclohexasiloxane, trimethyltriphenylcyclotrisiloxane, tetramethyltetra-phenylcyclotetrasiloxane, octaphenylcyclotetrasiloxane, which may be used alone or in a mixture of 2 or more compounds. The organosiloxane component is present in the constitution of the silicone component in the silicone-acrylate rubber to the extent of at least 50 wt. %, preferably at least 70 wt. %, based on the silicone component in the silicone-acrylate rubber.

As crosslinkers there are generally used tri- or tetra-functional silane compounds. The following are particularly preferred examples thereof: trimethoxymethyl-silane, triethoxyphenylsilane, tetramethoxysilane, tetraethoxysilane, tetra-n-propoxysilane, tetrabutoxysilane. Tetrafunctional branching agents, especiallytetraethoxysilane. The amount of branching agent is generally from 0 to 30 wt. % (based on the polyorganosiloxane component in the silicone-acrylate rubber).

In order to introduce graft-active sites into the polyorganosiloxane component of the silicone-acrylate rubber, there are preferably used compounds which form one of the following structures: 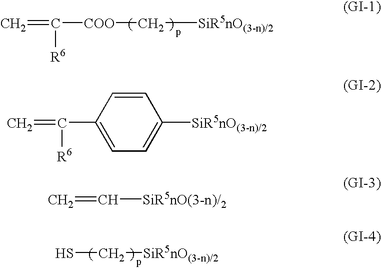
wherein

R⁵ represents methyl, ethyl, propyl or phenyl,

R⁶ represents hydrogen or methyl,

n represents 0, 1 or 2, and

p represents a number from 1 to 6.

(Meth)acryloyloxysilane is a preferred compound for forming the structure (GI 1). Preferred (meth)acryloyloxysilanes include β-methacryloyloxyethyl-dimethoxy-methyl-silane, γ-methacryloyl-oxy-propylmethoxy-dimethyl-silane, γ-methacryloyloxypropyl-dimethoxy-methyl-silane, γ-methacryloyloxypropyl-tri-methoxy-silane, γ-methacryloyloxy-propyl-ethoxy-diethyl-silane, γ-methacryloyl-oxypropyl-diethoxy-methyl-silane, γ-methacryloyloxy-butyl-diethoxy-methyl-silane.

Vinylsiloxanes, in particular tetramethyl-tetravinyl-cyclotetrasiloxane, are suitable for forming the structure GI-2.

p-Vinylphenyl-dimethoxy-methylsilane, for example, is suitable for the preparation of GI-3. γ-Mercaptopropyldimethoxy-methylsilane, γ-mercaptopropylmethoxy-dimethylsilane, γ-mercaptopropyldiethoxymethylsilane, etc. are suitable for forming the structure (GI-4).

The amount of these compounds is from 0 to 10 wt. %, preferably from 0.5 to 5 wt. % (based on the polyorganosiloxane component).

The acrylate component in the silicone-acrylate composite rubber may be prepared from alkyl (meth)acrylates, crosslinkers and graft-active monomer units.

Examples of preferred alkyl (meth)acrylates include alkyl acrylates, such as methyl acrylate, ethyl acrylate, n-propyl acrylate, n-butyl acrylate, 2-ethylhexyl acrylate, and alkyl methacrylates, such as hexyl methacrylate, 2-ethylhexyl methacrylate, n-lauryl methacrylate, and particularly preferably n-butyl acrylate.

Multifunctional compounds are used as crosslinkers. Examples include: ethylene glycol dimethacrylate, propylene glycol dimethacrylate, 1,3-butylene glycol dimethacrylate and 1,4-butylene glycol dimethacrylate.

The following compounds individually or in mixtures with one another, may be used to insert graft-active sites: allyl methacrylate, triallyl cyanurate, triallyl isocyanurate, allyl methacrylate. Allyl methacrylate may also act as crosslinker. These compounds are used in amounts of from 0.1 to 20 wt. %, based on the acrylate rubber component in the silicone-acrylate composite rubber.

Methods of producing the silicone-acrylate composite rubbers which are preferably used in the compositions according to the invention, and the grafting thereof with monomers, are described, for example, in U.S. Pat. No. 4,888,388, JP 08 259 791 A2, JP 07 316 409A and EP-A 0 315 035. As the graft base B.2 for the graft polymer B there are suitable both those silicone-acrylate composite rubbers whose silicone and acrylate components form a core-shell structure, and those which form a network in which the acrylate and silicone components have penetrated one another completely (interpenetrating network).

The graft polymerisation onto the above-described graft bases may be carried out in suspension, dispersion or emulsion. Continuous or discontinuous emulsion polymerisation is preferred. The graft polymerisation is carried out with free-radical initiators (e.g. peroxides, azo compounds, hydroperoxides, persulfates, perphosphates) and optionally using anionic emulsifiers, e.g. carboxonium salts, sulfonic acid salts or organic sulfates. There are formed thereby graft polymers with high graft yields, i.e. a large proportion of the polymer of the graft monomers is bonded chemically to the rubber.

For the formation of the graft shell B.1 there are preferably used mixtures of

B.1.1 from 0 to 80 wt. %, preferably from 0 to 50 wt. %, especially from 0 to 25 wt. % (based on the graft shell), of vinyl aromatic compounds or vinyl aromatic compounds substituted on the ring (such as, for example, styrene, α-methylstyrene, p-methylstyrene), vinyl cyanides (unsaturated nitriles, such as acrylonitrile and methacrylonitrile), and

B.1.2 from 100 to 20 wt. %, preferably from 100 to 50 wt. %, especially from 100 to 75 wt. % (based on the graft shell), of monomers selected from the group of the (meth)acrylic acid (C₁-C₈)-alkyl esters (such as methyl methacrylate, n-butyl acrylate, tert.-butyl acrylate) and derivatives (such as anhydrides and imides) of unsaturated carboxylic acids (such as maleic anhydride and N-phenylmaleimide).

The graft shell consists particularly preferably of a homopolymer of (meth)acrylic acid (C₁-C₈)-alkyl ester or of a mixture of a plurality of such esters, in particular of homopolymeric methyl methacrylate.

The gel content of the graft base B.2 is determined at 25° C. in a suitable solvent (M. Hoffmann, H. Krömer, R. Kuhn, Polymeranalytik I und II, Georg Thieme-Verlag, Stuttgart 1977).

The median particle size d₅₀ is the diameter above and below which in each case 50 wt. % of the particles lie. It can be determined by measurement by means of an ultracentrifuge (W. Scholtan, H. Lange, Kolloid-Z. und Z. Polymere 250 (1972), 782-796).

Component B may further include one or more thermoplastic vinyl (co)polymers B.3.

Suitable vinyl (co)polymers B.3 are polymers of at least one monomer from the group of the vinyl aromatic compounds, vinyl cyanides (unsaturated nitriles), (meth)acrylic acid (C₁ to C₈)-alkyl esters, unsaturated carboxylic acids and derivatives (such as anhydrides and imides) of unsaturated carboxylic acids. Particularly suitable are (co)polymers of

B.3.1 from 50 to 99 parts by weight, preferably from 60 to 80 parts by weight, of vinyl aromatic compounds and/or vinyl aromatic compounds substituted on the ring (such as, for example, styrene, α-methylstyrene, p-methylstyrene, p-chlorostyrene) and/or methacrylic acid (C₁ to C₈)-alkyl esters (such as methyl methacrylate, ethyl methacrylate), and

B.3.2 from 1 to 50 parts by weight, preferably from 20 to 40 parts by weight, of vinyl cyanides (unsaturated nitriles), such as acrylonitrile and methacrylonitrile, and/or (meth)acrylic acid (C₁-C₈)-alkyl esters (such as methyl methacrylate, n-butyl acrylate, tert.-butyl acrylate) and/or unsaturated carboxylic acids (such as maleic acid) and/or derivatives (such as anhydrides and imides) of unsaturated carboxylic acids (for example maleic anhydride and N-phenylmaleimide).

The (co)polymers B.3 are resinous, thermoplastic and free of rubber.

Particular preference is given to the copolymer of B.3. 1 styrene and B.3.2 acrylonitrile.

The required component B.4 is a terpolymer of styrene, acrylonitrile and maleic anhydride. The amount of maleic anhydride in the terpolymer is generally from 0.2 to 5 mol. %, preferably from 0.1 to 1.5 mol. % (see also EP-A 785 234). The terpolymer used for imparting compatibility. The compositions generally comprise from 0.1 to 10 wt. %, preferably from 0.3 to 7 wt. %, particularly preferably from 0.5 to 6 wt. %, especially from 0.8 to 4 wt. % (based on A and B), of terpolymer B.4.

The (co)polymers according to B.3 are known and can be prepared by free-radical polymerisation, in particular by emulsion, suspension, solution or mass polymerisation. The (co)polymers preferably have mean molecular weights M_{w} (weight average, determined by light scattering or sedimentation) of from 15,000 to 200,000.

Component C

Long glass fibers represent an endless or continuous glass fiber, the length of which is only limited by the capacity of the spool whereon the filament is wound. The resulting fiber length in the granules is determined by the cut length of the granules, that is to say the cut length of the granules is from 5 to 50 mm, preferably from 5 to 30 mm, particularly preferably from 7 to 25 mm (the term granules as used herein refers to the pellets. Pellets are the typical form in which molding compositions that include resinous components with or without additives are available in commerce). Typically, a fiber filament has a diameter of from 7 to 25 micrometers, preferably from 7 to 21 micrometers.

The long glass fibers may be surface-modified with a so-called size and are soaked or impregnated with the thermoplastics or thermoplastics blends used. In order to ensure good mechanical properties in the -fiber-containing granules and especially in the component produced therefrom, wetting or impregnation that is as good as possible should be achieved. Impregnation techniques are described, for example, in WO 95/28266 and U.S. Pat. No. 6,530,246 B 1 incorporated herein by reference.

The compositions may comprise further additives (component D). They may accordingly be rendered flame-resistant by the addition of suitable additives (in particular polycarbonate-based compositions). Examples of flameproofing agents which may be mentioned include halogen compounds, in particular compounds based on chlorine and bromine, as well as phosphorus-containing compounds.

The compositions preferably comprise phosphorus-containing flameproofing agents from the groups of the monomeric and oligomeric phosphoric and phosphonic acid esters, phosphonate amines and phosphazenes, it also being possible to use as flameproofing agents mixtures of a plurality of components selected from one of these groups or from various of these groups. Phosphorus compounds not mentioned specifically here can also be used, alone or in any desired combination with other flameproofing agents.

Preferred monomeric and oligomeric phosphoric and phosphonic acid esters are phosphorus compounds of the general formula (IV) 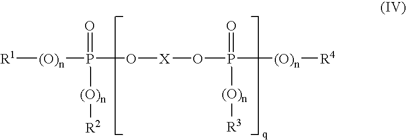
wherein

R¹, R ², R³ and R⁴ each independently of the others represents optionally halogenated C₁- to C₈-alkyl, or C₅- to C₆-cycloalkyl, C₆- to C₂₀-aryl or C₇-to C₁₂-aralkyl each optionally substituted by alkyl, preferably C₁- to C₄-alkyl, and/or by halogen, preferably chlorine, bromine,

each of the substituents n independently of the others represents 0 or 1,

q represents from 0 to 30, and

X represents a mono- or poly-nuclear aromatic radical having from 6 to 30 carbon atoms, or a linear or branched aliphatic radical having from 2 to 30 carbon atoms, which may be OH-substituted and may contain up to 8 ether bonds.

R¹, R², R³ and R⁴ each independently of the others preferably represents C₁- to C₄-alkyl, phenyl, naphthyl or phenyl-C₁-C₄-alkyl. The aromatic groups R¹, R², R³ and R⁴ may themselves be substituted by halogen and/or alkyl groups, preferably by chlorine, bromine and/or by C₁- to C₄-alkyl. Particularly preferred aryl radicals are cresyl, phenyl, xylenyl, propylphenyl or butylphenyl and the corresponding brominated and chlorinated derivatives thereof.

X in formula (IV) preferably represents a mono- or poly-nuclear aromatic radical having from 6 to 30 carbon atoms. The radical is preferably derived from diphenols of formula (I).

each of the substituents n in formula (IV), independently of the others, may be 0 or 1, preferably n is equal to 1.

q represents values of from 0 to 30. The components of formula (IV) may also be in the form of mixtures, in which case the q values, number-average, are from 0.3 to 20, particularly preferably from 0.5 to 10, especially from 0.5 to 6.

X particularly preferably represents 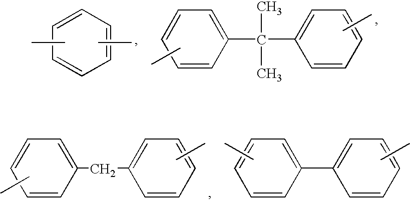
or the chlorinated or brominated derivatives thereof; in particular, X is derived from resorcinol, hydroquinone, bisphenol A or diphenylphenol. X is derived particularly preferably from bisphenol A.

The compositions comprise flameproofing agents generally in an amount of from 0.5 to 25 wt. %, preferably from 1 to 20 wt. %, based on 100 parts of A) and B).

The use of oligomeric phosphoric acid esters of formula (W) derived from bisphenol A is particularly advantageous, because the compositions provided with this phosphorus compound exhibit particularly high stress cracking resistance and hydrolytic stability as well as a particularly low tendency to the formation of a coating during processing by injection molding. Furthermore, particularly high dimensional stability under heat can be achieved with these flameproofing agents.

Monophosphorus compounds of formula (IV) are in particular tributyl phosphate, tris-(2-chloroethyl) phosphate, tris-(2,3-dibromopropyl) phosphate, triphenyl phosphate, tricresyl phosphate, diphenylcresyl phosphate, diphenyloctyl phosphate, diphenyl-2-ethylcresyl phosphate, tri-(isopropylphenyl) phosphate, halo-substituted aryl phosphates, methylphosphonic acid dimethyl ester, methylphosphonic acid diphenyl ester, phenylphosphonic acid diethyl ester, triphenylphosphine oxide or tricresylphosphine oxide.

The phosphorus compounds according to component D of formula (IV) are known (see e.g. EP-A 0 363 608, EP-A 0 640 655) and may be prepared by known methods in an analogous manner (e.g. Ullmanns Enzyklopädie der technischen Chemie, Vol. 18, p. 301 ff. 1979; Houben-Weyl, Methoden der organischen Chemie, Vol. 12/1, p. 43; Beilstein Vol. 6, p. 177).

The (number average) q values may be determined by analyzing the composition of the phosphate mixture for its molecular weight distribution—by any suitable method such as gas chromatography (GC), high pressure liquid chromatography (HPLC), gel permeation chromatography (GPC)—and calculating the number average therefrom.

Further suitable flameproofing agents include organic halogen compounds, such as decabromobisphenyl ether, tetrabromobisphenol, inorganic halogen compounds, such as ammonium bromide, nitrogen compounds, such as melamine, melamine-formaldehyde resins, inorganic hydroxide compounds, such as Mg, Al hydroxide, inorganic compounds, such as antimony oxides, barium metaborate, hydroxoantimonate, zirconium oxide, zirconium hydroxide, molybdenum oxide, ammonium molybdate, zinc borate, ammonium borate, barium metaborate, talc, silicate, silicon oxide and tin oxide, as well as siloxane compounds.

The flameproofing agents are often used in combination with so-called antidripping agents, which reduce the tendency of the material to produce burning drips in case of fire. Examples which may be mentioned here are compounds of the substance classes of the fluorinated polyolefins, of the silicones, as well as aramid fibers. These may also be used in the compositions according to the invention. Fluorinated polyolefins are preferably used as antidripping agents.

Fluorinated polyolefins are known and are described, for example, in EP-A 0 640 655. They are marketed, for example, by DuPont under the trade mark Teflon® 30N.

The fluorinated polyolefins may be used either in pure form or in the form of a coagulated mixture of emulsions of the fluorinated polyolefins with emulsions of the graft polymers (component B) or with an emulsion of a copolymer, preferably a copolymer based on styrene/acrylonitrile, the fluorinated polyolefin being mixed in the form of an emulsion with an emulsion of the graft polymer or of the copolymer and subsequently being coagulated.

The fluorinated polyolefins may also be used in the form of a precompound with the graft polymer (component B) or with a copolymer, preferably a copolymer based on styrene/acrylonitrile. The fluorinated polyolefins are mixed in the form of a powder with a powder or with granules of the graft polymer or copolymer and are compounded in the melt, generally at temperatures of from 200 to 330° C., in conventional devices such as internal kneaders, extruders or twin-shaft screws.

The fluorinated polyolefins can also be used in the form of a masterbatch, which is prepared by emulsion polymerisation of at least one monoethylenically unsaturated monomer in the presence of an aqueous dispersion of the fluorinated polyolefin. Preferred monomer components are styrene, acrylonitrile and mixtures thereof. After acid precipitation and subsequent drying, the polymer is used in the form of a pourable powder.

The coagulates, precompounds or masterbatches usually have solids contents of fluorinated polyolefin of from 5 to 95 wt. %, preferably from 7 to 60 wt. %.

Antidripping agents may be present in the composition according to the invention in an amount of preferably from 0.05 to 5 wt. %, particularly preferably from 0.1 to 1 wt. % and most preferably from 0.1 to 0.5 wt. % (based on A) and B)).

The molding compositions according to the invention may further comprise at least one of the conventional additives, such as lubricants and mould-release agents, for example pentaerythritol tetrastearate, nucleating agents, antistatics, stabilisers, and, in addition to the inorganic materials having the chosen aspect ratio, inorganic materials having a different geometry, such as further fillers and reinforcing agents, as well as coloring and pigments.

Components A) and B) and optionally further added ingredients and additives may be mixed in a known manner and melt-compounded or melt-extruded at temperatures of from 200° C. to 300° C. in conventional devices such as internal kneaders, extruders and twin-shaft screws.

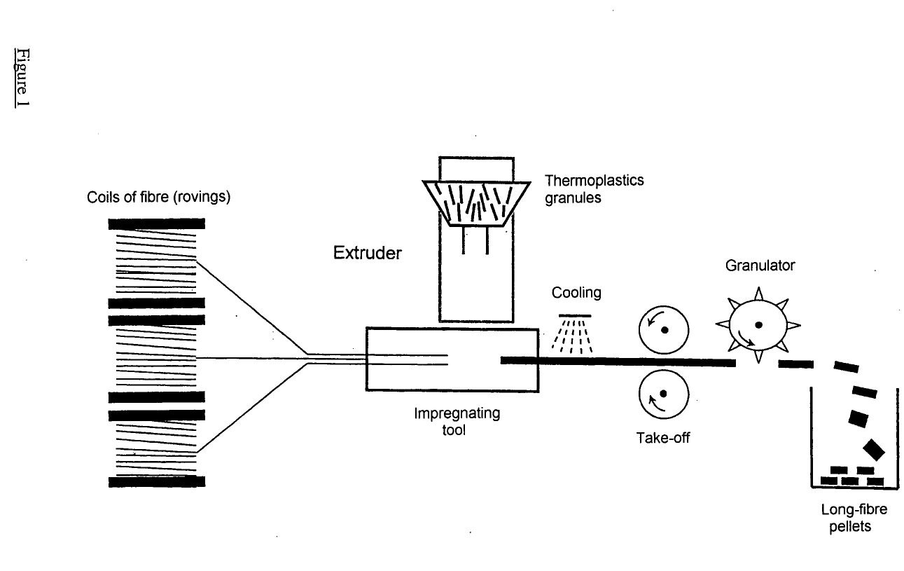

The individual constituents may be mixed in a known manner either in succession or simultaneously, either at about 20° C. (room temperature) or at a higher temperature. The long glass fibers are supplied in the form of continuous so-called rovings or glass-fiber bundles in an installation to which the molten thermoplastic or thermoplastics blend is also supplied (see WO 95/28266 and U.S. Pat. No. 6,530,246 B1). This means that the long glass fibers with or without other fibers, such as carbon or aramid fibers, are subjected continuously to the wetting or impregnating process (diagrammatic representation according to FIG. 1). The number of individual filaments in a roving is from 200 to 20,000, preferably from 300 to 10,000, particularly preferably from 500 to 2000.

The molding compositions according to the invention may be used in the production of molded articles of any kind. The molded articles may be produced by injection molding, extrusion and blow molding methods. A further form of processing is the production of molded articles by deep-drawing from previously produced sheets or films.

The glass fibers present in the resulting molded article have a mean fiber length of from 0.5 to 50 mm, preferably from 1.0 to 40 mm, particularly preferably from 1.5 to 15 mm, and at least 40%, preferably at least 70%, particularly preferably at least 80% of the glass fibers having a length greater than 1 mm.

The filaments are arranged unidirectionally in the granules.

Articles molded of the glass-fiber-reinforced thermoplastics according to the invention possess good mechanical properties which are superior to those of counterparts where the fibers are short. Short-fiber-reinforced thermoplastics are materials in which the fibers in the form of chopped glass are mixed with the further components in an extruder. Typically, short-fiber-reinforced thermoplastics have a glass fiber length in the granules of from 0.2 to 0.5 mm. The fibers are present in the short-fiber granules in a random, that is to say unordered, manner.

Examples of molded articles produced from fiber-reinforced thermoplastics according to the invention are films, profiles, casing parts of any kind, e.g. for motor vehicle interiors, such as instrument panels, domestic appliances, such as juice extractors, coffee machines, mixers; for office equipment, such as monitors, printers, copiers; for sheets, tubes, conduits for electrical installations, windows, doors and profiles for the construction sector, interior finishing and external applications; in the field of electrical engineering, such as for switches and plugs.

The present invention accordingly also provides a process for the production of molding compositions reinforced with long glass fibers and comprising at least one polymer selected from the group of the polyamides, polycarbonates, polyester carbonates, graft polymers and copolymers, as well as a terpolymer of styrene, acrylonitrile and maleic anhydride.

The process for the production of the thermoplastic compositions according to the invention in the form of granules is characterised in that

i) a bundle of long glass fibers, the diameter of the fiber filament being from 7 to 25 μm, is wetted with the melt of optionally at least one polymer selected from the group of the polyamides, polycarbonates and polyester carbonates, with the melt of at least one polymer selected from the group of the graft polymers and copolymers, and with the melt of a terpolymer of styrene, acrylonitrile and maleic anhydride,

ii) is cooled and

iii) the wetted fiber bundle is cut into granules having a cut length of from 5 to 50 mm.

Preferably, the process for the production of the thermoplastic compositions according to the invention in the form of granules is characterised in that

i) a bundle of long glass fibers, the diameter of the fiber filament being from 7 to 25 μm, is wetted with the melt of at least one polymer selected from the group of the polyamides, polycarbonates and polyester carbonates, with the melt of at least one polymer selected from the group of the graft polymers and copolymers, and with the melt of a terpolymer of styrene, acrylonitrile and maleic anhydride,

ii) is cooled and

iii) the wetted fiber bundle is cut into granules having a cut length of from 5 to 50 mm.

In the context of the present invention “wetted” means that the glass fibre is at least partially dampened/brought into contact with the molten polymer component in order to obtain adhesion between the glass fiber and the polymer.

The Examples which follow serve to explain the invention further.

### EXAMPLES

The components indicated in Tables 1 and 2 and described briefly hereinbelow are compounded at about 240° C. using a 3-litre internal kneader or a ZSK-25. The molded articles are produced at 240°/260° C. on an Arburg 270 E injection-molding machine.

The long glass fibers are incorporated in accordance with WO 95/28266, see also FIG. 1.

Component A 1

Linear homopolycarbonate based on bisphenol A and having a relative solution viscosity of 1.24, measured in CH₂Cl₂ as solvent at 25° C. and a concentration of 0.5 g/100 ml.

Component A2

Linear homopolycarbonate based on bisphenol A and having a relative solution viscosity of 1.28, measured in CH₂Cl₂ as solvent at 25° C. and a concentration of 0.5 g/100 ml.

Component B 1

Graft polymer of 40 parts by weight of a copolymer of styrene and acrylonitrile in a ratio of 73:27 on 60 parts by weight of particulate cross-linked polybutadiene rubber (median particle diameter (d₅₀)=0.3 μm), prepared by emulsion polymerisation.

Component B2

Styrene/acrylonitrile copolymer having a styrene/acrylonitrile weight ratio of 72:28 and an intrinsic viscosity of 0.55 dl/g (measured in dimethylformamide at 20° C.).

Component B3

Metablen SRK200, styrene/acrylonitrile-grafted silicone-butyl acrylate composite rubber from Mitsubishi Rayon Co. Ltd. Tokyo, Japan.

Component B4

Terpolymer of styrene/acrylonitrile/maleic anhydride containing 66.4 wt. % styrene, 32.5 wt. % acrylonitrile and 1.1 wt. % maleic anhydride; melt index: 8.5 g/10 min (200° C., 5 kg load).

Component C1

R43SX6 type 30® (long glass fibers, average diameter 17 μm), Owens Corning (Battice, Belgium).

Component C2

Glass fibers (CS 7942, Bayer AG, Leverkusen, Germany), cut, average length is 4.5 mm.

Pentaerythritol stearate (PETS) and phosphite stabiliser are used as additives. The following compositions A and B are used in Examples 1 to 10:

A: 17.9 parts by weight of A1
43.0 parts by weight of A2
5.4 parts by weight of B3
23.3 parts by weight of B2
0.4 part by weight of PETS
0.1 part by weight of phosphite stabiliser

B: 60.9 parts by weight of A1
14.3 parts by weight of B 1
14.3 parts by weight of B2
0.5 part by weight of PETS
0.1 part by weight of phosphite stabiliser

Composition C is a mixture comprising composition A or B and optionally further components with in each case 20 wt. % long glass fibers (component C1) or with in each case 10 or 20 wt. % glass fibers (component C2), to which the further components mentioned in Table 1 are added. Because the metering of the long glass fibers can be associated with slight deviations, the amount of fibers determined after grinding is indicated in Table 1 and 2.

The tensile strength is determined in accordance with ISO EN 527, the modulus of elasticity in accordance with ISO 527, and the Charpy impact strength (unnotched) in accordance with ISO 179 1eU.

TABLE 1
Polycarbonate compositions and their properties

| | | | | | | Values standardised to ground | | |
|---|---|---|---|---|---|---|---|---|
| | | | | | | fiber content¹⁾ | | |
| | | | | | | Standardisation to 20 wt. % | | |
| | Composition C | | | Modulus | | glass fibers | | |
| | A or B + opt. | +C1 or | Tensile | of | Unnotched | Tensile | Modulus of | Unnotched |
| | B4 + B2 | C2 | strength | elasticity | Charpy | strength | elasticity | Charpy |
| Example | [wt. %] | [wt. %] | MPa | MPa | kJ/m² | MPa | MPa | kJ/m² |
| 1 | A | 19.8 C1 | 91.70 | 7110 | 27 | 92.63 | 7182 | 27.27 |
| (comp.) | | | | | | | | |
| 2 | A + 1% B4 | 19.8 C1 | 94.20 | 7221 | 28.7 | 95.15 | 7294 | 28.99 |
| 3 | A + 2% B4 | 19.9 C1 | 93.90 | 7199 | 25.2 | 94.37 | 7235 | 25.33 |
| 4 | A + 3% B4 | 20.2 C1 | 95.00 | 7334 | 25.6 | 94.06 | 7261 | 25.35 |
| 5 | A + 2% B4 + | 20.3 C1 | 99.00 | 7381 | 26 | 97.54 | 7272 | 25.62 |
| | 5% B2 | | | | | | | |
| 6 | A + 2% B4 + | 20.5 C1 | 100.80 | 7701 | 23.9 | 98.34 | 7513 | 23.32 |
| | 10% B2 | | | | | | | |
| 7 | A + 2% B4 + | 20.2 C1 | 99.20 | 7815 | 23.1 | 98.22 | 7738 | 22.87 |
| | 15% B2 | | | | | | | |
| 8 | B + 2% B4 | 22.4 C1 | 101.40 | 7296 | 33.3 | 90.54 | 6514 | 29.73 |
| 9 | B | 20 C2 | 77 | 5900 | 20 | 77 | 5900 | 20 |
| (comp.) | | | | | | | | |
| 10 | A | 10 C2 | 75 | 4200 | 24 | 75 | 4200 | 24 |
| (comp.) | | | | | | | | |

¹⁾Standardisation to 20 wt. % glass fiber content is based on the assumption that at small deviations from 20 wt. % there is a linear correlation between the amount of glass fibers and the property. Because the amount of glass fiber in every pellet may vary from one pellet to another the “real content” of glass fiber in the pellet was measured by grinding the residue of a burned pellet.

TABLE 2
Compositions and their properties

| | | | | Unnotched | Tensile | Modulus of | Elongation |
|---|---|---|---|---|---|---|---|
| | B2 | B4 | C1 | Charpy | strength | elasticity | at rupture |
| Example | [wt. %] | [wt. %] | [wt. %] | [kJ/mm2] | [MPa] | [GPa] | [%] |
| 11 | 66 | 0 | 33.6 | 19.4 | 127 | 10.8 | 1.35 |
| (comp.) | | | | | | | |
| 12 | 65.9 | 0.5 | 33.6 | 26.8 | 148 | 11.3 | 1.52 |
| 13 | 65.0 | 1.0 | 34.0 | 29.1 | 150 | 12.0 | 1.59 |
| 14 | 64.6 | 1.5 | 33.9 | 31.8 | 148 | 11.9 | 1.53 |
| 15 | 65.5 | 2.0 | 32.5 | 32.1 | 151 | 11.8 | 1.59 |
| 16 | 65.1 | 2.5 | 32.4 | 31.6 | 155 | 12.0 | 1.63 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
a) at least one polymer selected from the group consisting of polyamides, polycarbonates, polyester carbonates, graft polymers and copolymers,
b) a terpolymer of styrene, acrylonitrile and maleic anhydride and
c) long glass fibers, the diameter of the fiber filament being from 7 to 25 μm.

2. The composition of claim 1 wherein said (a) contains
A) at least one member selected from the group consisting of the polyamides, polycarbonates and polyester carbonates and
B) at least one member selected from the group consisting of graft polymers and copolymers

3. The composition of claim 1, wherein said terpolymer is present in an amount of 0.1 to 10 wt. % based on the weight of said (a).

4. The composition of claim 2, wherein said terpolymer is present in an amount of 0.1 to 10 wt. % based on the weight of said (a).

5. The composition of claim 1, wherein said terpolymer is present in an amount of 0.2 to 5 wt. % based on the weight of said (a).

6. The composition of claim 2, wherein said terpolymer is present in an amount of 0.2 to 5 wt. % based on the weight of said (a).

7. The compositions according to claim 2, wherein said copolymer is the polymerization product of
50 to 99 parts by weight of at least one member selected from the group consisting of vinyl aromatic compounds, vinyl aromatic compounds substituted on the ring and methacrylic acid (C₁ to C₈)-alkyl esters and
1 to 50 parts by weight of at least one member selected from the group consisting of vinyl cyanides, (meth)acrylic acid (C₁-C8)-alkyl esters, unsaturated carboxylic acids, and derivatives of unsaturated carboxylic acids.

8. A process for the production of thermoplastic compositions in the form of granules comprising
i) wetting a bundle of long glass fibers, having diameters of 7 to 25 μm, with the melt of at least one member selected from the group consisting of polyamides, polycarbonates and polyester carbonates, and with the melt of a terpolymer of styrene, acrylonitrile and maleic anhydride, and optionally with the melt of at least one member selected from the group of the graft polymers and copolymers, to obtain a wet fiber bundle and
ii) cooling the wet fiber bundle, and
iii) cutting the cooled wet fiber bundle into granules having a length of 5 to 50 mm.

9. The process of claim 8, wherein the length is 5 to 50 mm.

10. The process of claim 8, wherein the length is 5 to 30 mm.

11. The process of claim 8, wherein the length is 7 to 25 mm.

12. The process of claim 8, wherein the length is 7 to 21 mm.

13. A molded article comprising the composition of claim 1 wherein mean length of the long glass fibers present in the article is 0.5 to 50 mm.

14. The article of claim 13 wherein the length is 1.5 to 15 mm.

15. The article of claim 13, wherein at least 40% of the glass fibers have lengths greater than 1 mm.

16. The article of claim 13, wherein at least 70% of the glass fibers have lengths greater than 1 mm.
